(19) United States
(12) Patent Application Publication
(10) Pub. No.: US 2011/0320357 A1
(43) Pub. Date: Dec. 29, 2011

(54) SYSTEM AND METHOD FOR REAL-TIME STRAIGHT THROUGH PROCESSING AND REAL-TIME PRESENTMENT OF CHECKS

(75) Inventor: Jonathan C. Gilson, Richardson, TX (US)

(73) Assignee: ARGO DATA RESOURCE CORPORATION, Richardson, TX (US)

(21) Appl. No.: 13/096,875

(22) Filed: Apr. 28, 2011

Related U.S. Application Data
(60) Provisional application No. 61/358,519, filed on Jun. 25, 2010.

(51) Int. Cl. G06Q 40/00

(52) U.S. Cl. 705/45

(57) ABSTRACT

Methods, systems, and apparatus, including computer programs encoded on a computer storage medium, are disclosed for real-time, straight-through processing and real-time presentment of checks and other electronic payment instruments. In one aspect, an image file associated with a payment item received at a first financial institution is generated. The generated image file is transmitted to a second financial institution associated with the payment item immediately after generation of the image file, while the received payment item and generated image file are processing prior to posting a transaction to a customer account at the first financial institution. After completing the processing, a transit item associated with the processed payment item is generated and transmitted to the second financial institution for association with the previously-transmitted image file.

### CLAIM OF PRIORITY

This application claims priority under 35 U.S.C. §119 to U.S. Provisional Application No. 61/358,519, filed Jun. 25, 2010, the entire disclosure of which is incorporated herein by reference.

### TECHNICAL FIELD

The present disclosure relates to real-time, straight-through processing and real-time presentment of checks and other electronic payment instruments.

### BACKGROUND

Currently, the bank of first deposit (BOFD) receives a physical check, an image of a physical check, or any other acceptable check substitute (as well as other types of payment items), from an initial point of deposit including a point-of-sale, automated teller machine (ATM), teller system, or point-of-purchase, processes the check using any suitable technique, and then communicates the physical check, an image of the check, or the check substitute to the receiving (or payor/endpoint) bank for payment and forwarding to the appropriate account holder (maker). In certain situations the BOFD and the receiving (payor/endpoint) bank may be the same financial institution. In current systems, an image of the received physical check can be used with other information derived from the physical check and manual processing to generate a set of data generally describing the received check or payment item. In current systems, the teller or initial point of deposit performs various functions associated with the received payment item, and subsequently sends the check (or associated image and information) to a middle tier architecture where further processing is performed in order to generate a memo post to the appropriate account(s) within the BOFD's accounting systems.

Concurrently with, and continuing after this initial point of deposit processing, additional back-end processes of each check or payment item image are performed, including codeline verification of the scanned Magnetic Ink Character Recognition (MICR) line from the scanned check or payment item, an image quality analysis, an amount keying (if necessary), and fraud-related detection and suspect review, among others. Generally, these additional back-end processes are performed over the period of anywhere from several hours to several days, and may delay the conversion of credit and debit posting at the BOFD from a temporary, or intermediate, memo post to a final post. The back-end processes include sorting and forwarding the check or payment information to the receiving bank (payor/endpoint). The check or payment information is sent to the receiving bank (payor/endpoint) in batches based upon a certain specified period of time or specified volume threshold being reached. Upon receipt of the check or payment information from the BOFD, the receiving bank (payor/endpoint) will perform similar deposit and back-end processes to those of the BOFD prior to entering a final posting of the credits or debits associated with that item. Further, after all processing is completed at both the BOFD and receiving bank (payor/endpoint), adjusting transactions may be created and exchanged if any processing errors or fraudulent conditions have been encountered. These adjusting entries are performed over the period of anywhere from several hours to several days. Generally, the processed check and payment item images are stored in an image archive or repository by the BOFD and for future use and may also be stored in an image archive or repository by the receiving bank (payor/endpoint).

### SUMMARY

Methods, systems, and apparatus, including computer programs encoded on a computer storage medium, are disclosed for real-time, straight-through processing and real-time presentment of checks and other electronic payment instruments. In one aspect, an image file associated with a payment item received at a first financial institution (BOFD) is generated. The generated image file is transmitted to a second financial institution (receiving bank/payor bank/endpoint) associated with the payment item immediately after generation of the image file, while the received payment item and generated image file are processing prior to posting a transaction to a customer account at the first financial institution (BOFD). After completing the processing, a transit item associated with the processed payment item is generated and transmitted from the first financial institution (BOFD) to the second financial institution (receiving bank/payor bank/endpoint) for association with the previously-transmitted image file.

The details of one or more embodiments of the present disclosure are set forth in the accompanying drawings and the description below. Other features, objects, and advantages of the present disclosure will be apparent from the description and drawings, and from the claims.

### DESCRIPTION OF DRAWINGS

FIG. 1 is a general schematic diagram of a system for performing real-time, straight-through processing and real-time presentment of checks or other payment items.

FIG. 2 is a flowchart illustrating an example method for performing real-time, straight-through processing and real-time presentment of a check or other payment item from the perspective of the bank of first deposit (BOFD) in accordance with the system of FIG. 1.

FIG. 3 is a flowchart illustrating an example method for performing real-time, straight-through processing and real-time presentment of a check or other payment item from the perspective of a receiving bank (payor/endpoint) or financial institution associated with the check or payment item received at the bank of first deposit (BOFD) in accordance with the system of FIG. 1.

FIG. 4 is an example signaling and flow diagram illustrating operations associated with performing real-time, straight-through processing and real-time presentment of a check or other payment item, including the operations of a teller system, a middle tier architecture and host system associated with a bank of first deposit (BOFD), and a middle tier architecture and host system associated with a receiving bank (payor/endpoint) associated with the check and other payment item, in accordance with the system of FIG. 1.

### DETAILED DESCRIPTION

The present disclosure describes systems and methods for performing real-time, straight-through processing and real-time presentment of checks and other electronic payment items at a bank of first deposit (BOFD), as well as real-time, straight-through processing and presentment of checks and payment items at receiving (payor/endpoint) banks. Generally, the present disclosure describes systems and methods wherein checks and/or other payment items (e.g., a loan document, a direct deposit account entry, etc.) are presented to a BOFD through an initial deposit point including teller or teller-related application (including ATMs, customer-based web applications, merchant applications, automated clearing house (ACH), etc.), and subsequently immediately processed and finalized in real-time by a middle tier architecture associated with the BOFD. In other words, the processing of the check or payment item is performed immediately and in a straight-through manner, avoiding current check processing systems' requirements of significant and time-consuming back-end processing performed apart from and outside of the bank's middle tier architecture, which in turn adds significant delay to finalizing and completing transactions. One advantage of performing the check or payment item validation and processing in a straight-through and real-time manner is that the need for memo, or temporary, posting to a bank's host system is removed, such that only a final post is required. In this manner, the check or payment item is immediately processed and finalized at the BOFD, removing the need for check or payment item processing outside of the middle tier architecture's in-line systems, and, in most cases, allowing customers to receive a receipt reflecting a completed transaction during their real-time interactions with the BOFD.

In addition to the straight-forward and real-time processing performed at the BOFD, the receiving (payor/endpoint) bank can be provided with an image file representing the received check or payment item once the check or payment item has been scanned at the initial deposit point. In some instances, an initial review of the scanned image file can be performed at the BOFD's teller or middle tier architecture such that an expected receiving (payor/endpoint) bank of the check is determined (for instance, using information encoded in the MICR line of the received image file associated with the payment item). Once the expected receiving (payor/endpoint) bank is determined, the middle tier of the architecture of the BOFD transmits the scanned image file to the receiving (payor/endpoint) bank prior to any additional processing, providing the receiving (payor/endpoint) bank's middle tier architecture with the image file prior to any additional data being received. In this manner, the typically time-consuming process of providing large image files (at least compared to the data and information extracted from the check or payment file) can be performed immediately, in most cases allowing the image file associated with a received check to arrive at the receiving (payor/endpoint) bank prior to completion of the processing performed at the BOFD. Once the initial deposit processing and middle tier architecture processing at the BOFD is completed, any additional content and verification data will then be provided to the receiving (payor/endpoint) bank. Because the scanned image files are orders of magnitude larger than the data extracted from the scanned check or payment item, the initial transmission to and receipt of the scanned image file at the receiving (payor/endpoint) bank can allow for immediate check processing at the receiving (payor/endpoint) bank once the BOFD completes its real-time, straight-through processing.

Generally, transmissions between the BOFD and the receiving (payor/endpoint) bank will be performed between the respective middle tier architectures of the two systems, allowing for consistent and immediate communications between the middle tier architectures using common formats and communication protocols. Another advantage of the system in the present disclosure is that the system is infinitely scalable, in that middle tier architectures associated with any number of individual banks or other financial institutions can be added to the system, such that the middle tier architectures are loosely coupled to each other. Using secure networking protocols, the BOFD can transmit and receive information from any bank associated with and communicably coupled to the present system, allowing for consistent connections and communications of checks and payment items between systems, and allowing for real-time processing and presentment of checks and payment items. Still further, transactions that require no additional human or manual interaction processes at the middle tier architecture after receipt from the initial deposit point can be immediately sent to the receiving (payor/endpoint) bank. The present disclosure allows for real-time processing and presentment across any and all associated systems. Further, data transmission times can be minimized by separating the processes of the sending of scanned images to the receiving (payor/endpoint) bank from the sending of the related verification and check-based data and information, allowing the high bandwidth required by the image file transmission to be performed while the image file processing is being performed, thereby allowing the receiving (payor/endpoint) bank to immediately process a check or payment item once the BOFD completes its processing.

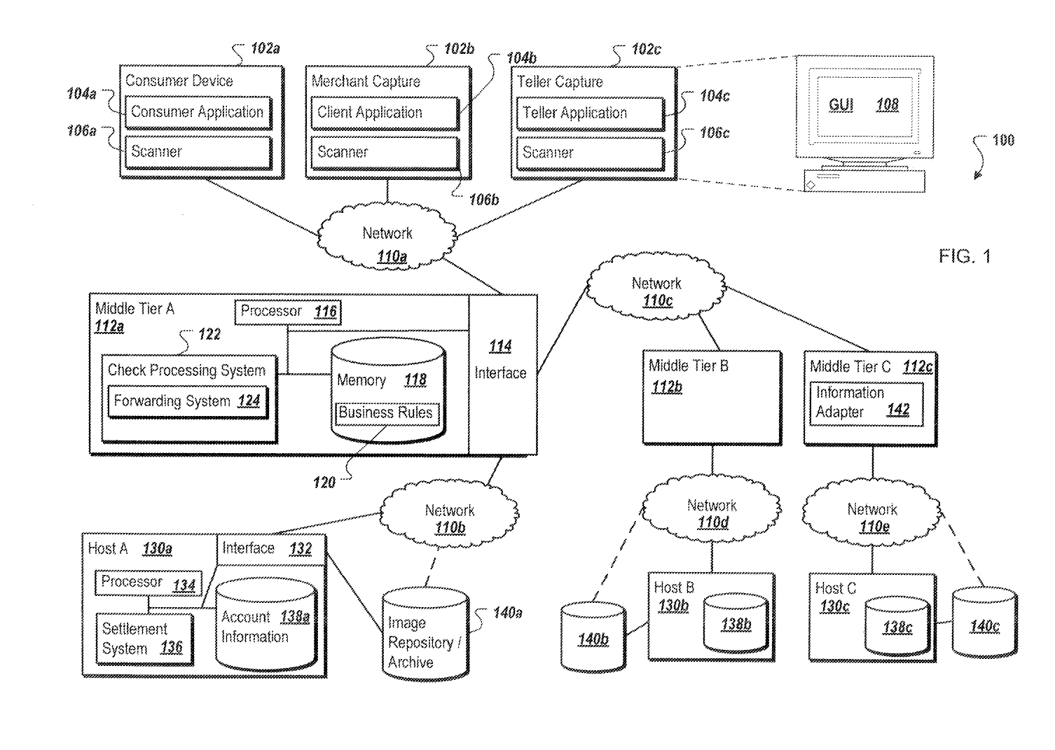

FIG. 1 illustrates a system 100 for performing real-time, straight-through processing and real-time presentment of checks and other payment items at a BOFD, as well as real-time, straight-through processing and presentment of checks and payment items at one or more receiving (payor/endpoint) banks in accordance with one embodiment of the present disclosure. Generally, system 100 includes at least a portion of any (and one or more) financial or banking system(s) operable to process commercial paper transactions (such as checking), generate or process image files associated with one or more checks or payment items for at least one transaction, and securely process, validate, and transmit these one or more checks and/or payment items. For example, system 100 may receive a physical check at one of a plurality of associated locations, including at a teller 102c located within a particular branch or location of a BOFD (e.g., Bank A, a financial institution associated with middle tier A 112a and host A 130a), a merchant capture location 102b associated with a merchant affiliated with Bank A, or a consumer capture device 102a with software and hardware that may allow a consumer to present a check or other payment item for presentment via the consumer capture device 102a. Using scanners 106a, b, and c associated with each of the respective devices, locations, or entities, image files of a physical check may be generated. In general, the image files of the received physical checks may include images of the front, the back, or both of the check or payment item, as well as a capture of the MICR line of the check. The image files may be in any suitable format including Moving Picture Experts Group (MPEG), Joint Photographic Experts Group (JPEG), Tag Image File Format (TIFF), including any suitable version thereof (such as TIFF 6.0), and others. In some instances, additional information may be provided at the respective locations or devices that may allow users of or at those locations to include additional information or metadata with the image file associated with the check, either as metadata associated with the file, one or more additional information files, or information included within the image files themselves.

The consumer capture device 102a may be a general purpose device or personal computer including or associated with a scanner 106a (e.g., a flatbed scanner, a multi-function printer with scanning capabilities, etc.) or another device capable of capturing images of the associated check or payment item. In some instances, the consumer capture device 102a may include a mobile device, such as a smartphone, in which the device's camera may be used in lieu of a traditional scanner to capture the image of the check or payment item. Additionally, the consumer capture device 102a may include or be loaded with a consumer capture application 104a that allows the consumer capture device 102a to perform check receiving and capturing operations and transmit the captured images and other relevant information to a particular bank, such as Bank A, via middle tier A 112a. As illustrated in FIG. 1, consumer capture device 102a may communicate its scanned image files to or via network 110a with middle tier A 112a of Bank A.

The merchant capture device 102b may be any device associated with a remote deposit system, or the ability to deposit checks and other payment items into a bank account from a merchant location (and/or residence) without requiring the customer, whether a business or consumer, to physically deliver the actual check or payment item to the BOFD. Similar to the consumer capture device 102a, the merchant capture device 102b uses a scanner 106b or other means to scan a digital image of a check onto a computer (e.g., a personal computer, a cash register, etc.), and transmit the image file result of the scanning to the associated bank using a client capture application 104b. In some instances, the client capture application 104b may be a Web-based or online application that can be accessible to the customer via an Internet connection, while in other instances, the client capture application 104b may be a client-based application executed locally on the merchant capture device 102b capable of using a network connection to transmit the scanned image files and, in some instances, any additional information provided by the customer or extracted/determined by the client capture application 104b, to the associated financial institution (here, Bank A).

Teller capture device 102c represents the traditional teller experience and devices associated with a personal teller or financial institution representative at a bank. In this instance, a typical teller-customer interaction is considered, where the customer may provide one or more checks or payment items to the teller, who in turn may use a scanner 106c associated with a teller application 104c to capture, process, and transmit check or payment item information to the associated middle tier A 112a of the respective financial institution. Additionally, the teller capture device's scanner 106c (as well as scanners 106a and b) may also include a MICR reader for capturing MICR-line check data from the received check or payment item, in addition to a digital image of the MICR line itself. The teller capture device 102c may be a general purpose computer located at the corresponding financial institution, or the teller capture device 102c may be specifically designed or generated for receiving, scanning, and processing incoming check and payment items. In either event, the teller capture device 102c is capable of capturing the requisite images associated with the received check, generating a suitable image file storing said images, and transmitting that data to the associated middle tier A architecture 112a associated with the teller capture device 102c. In some instances, the teller capture device 102c may execute a browser-based teller solution.

Teller capture device 102c is further illustrated as including a graphical user interface (GUI) 108. The GUI 108 comprises a graphical user interface operable to, for example, allow the user of the teller capture device 102c to interface with at least a portion of the teller capture application 104c, as well as any other purpose associated with the teller capture device 102c, such as creating, preparing, requesting, or analyzing data, as well as viewing and accessing customer account information associated with financial transactions. Generally, the GUI 108 provides the particular user with an efficient and user-friendly presentation of business data provided by or communicated within the system. The GUI 108 may comprise a plurality of customizable frames or views having interactive fields, pull-down lists, and buttons operated by the user. For example, GUI 108 may provide interactive elements that allow a user to enter or select data associated with financial transactions in GUI 108. More generally, GUI 108 may also provide general interactive elements that allow a user to access and utilize various services and functions of teller capture application 104c. The GUI 108 is often configurable, can support a combination of tables and graphs (bar, line, pie, status dials, etc.), and may be able to access one or more web sites associated with financial transactions. Therefore, the GUI 108 contemplates any suitable graphical user interface, such as a combination of a generic web browser, intelligent engine, and command line interface (CLI) that processes information in the platform and efficiently presents the results to the user visually. Although not illustrated as such, both consumer capture device 102a and merchant capture device 102b include GUIs allowing users of those devices to perform similar operations and enter information associated with financial transactions (including the corresponding applications), as well as other operations incidental to the use of those devices.

Generally, the consumer capture device 102a, merchant capture device 102b, and teller capture device 102c may be communicably coupled with a network 110 that facilitates wireless or wired communications between the components of the environment 100 (i.e., between the described devices 102 and middle tier architecture 112a), as well as with any other local or remote computer, such as additional clients, servers, or other devices communicably coupled to network 110 but not illustrated in FIG. 1. In the illustrated environment, the network 110 is depicted as multiple continuous and discontinuous networks or connections between various components in FIG. 1 (e.g., networks 110a-e). However, network 110 may be a single network without departing from the scope of this disclosure, so long as at least a portion of the network 110 may facilitate communications between senders and recipients. The network 110 may be all or a portion of an enterprise or secured network, while in another instance, at least a portion of the network 110 may represent a connection to the Internet. In some instances, a portion of the network 110 may be a virtual private network (VPN), such as, for example, the connection between the consumer capture device 102a and the middle tier A 112a. Further, all or a portion of the network 110 can comprise either a wired or wireless link. Example wireless links may include 802.11a/b/g/n, 802.20, WiMax, and/or any other appropriate wireless link. In other words, the network 110 encompasses any internal or external network, networks, sub-network, or combination thereof operable to facilitate communications between various computing components inside and outside the illustrated environment 100. The network 110 may communicate, for example, Internet Protocol (IP) packets, Frame Relay frames, Asynchronous Transfer Mode (ATM) cells, voice, video, data, and other suitable information between network addresses. The network 110 may also include one or more local area networks (LANs), radio access networks (RANs), metropolitan area networks (MANs), wide area networks (WANs), all or a portion of the Internet, and/or any other communication system or systems at one or more locations. Different portions of the network 110 may be distinct from other portions in order to compartmentalize or limit the interactions and communications sent between components. For instance, the consumer capture device 102a may not be able to communicate over network 110e (the connection between middle tier C 112c and host C 130c. Additionally, communications across the network 110 may be encrypted in order to protect the transmitted data, and may be encrypted using protocols and encryption methods supported and/or required by the financial services industry, regulatory agencies, and other requirements or standards.

Once a check or payment item is captured by a receiving device (i.e., the consumer capture device 102a, the merchant capture device 102b, or the teller capture device 102c), the image file associated with the captured and scanned check or payment item is sent to middle tier A 112a. In some instances, middle tier A 112a comprises one or more application servers providing an event-driven middleware system that provides business-rule integration across one or more financial organizations, including the processing of financial transactions, such as operations for check and payment item processing. In general, middle tier A 112a may be any server (or set of servers) that stores one or more check processing systems 122, where at least a portion of the check processing system 122 is executed via requests and responses sent between the various devices 102a-c communicably coupled with the middle tier A 112a. The check processing system 122 can perform any number of operations on received images associated with checks and payment items, including MICR codeline verification, image quality analysis, amount keying, fraud detection, and suspect review. Generally, these processing steps analyze the received document to determine additional information included within the associated payment instrument, while also confirming any information received with the image files from the consumer capture application 104a, the merchant client capture application 104b, the teller capture application 104c, or any other source of incoming payment items associated with the middle tier A 112a.

In one example, the middle tier A 112a may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, middle tier A 112a may store a plurality of related applications and processes, while in other instances, the middle tier A 112a may be a dedicated server meant to store and execute only a single check processing system 122. In some instances, the middle tier A 112a may comprise a web server or be communicably coupled with a web server, where the check processing system 122 represents one or more web-based applications accessed and executed via network 110 by clients of the system to perform the programmed tasks or operations of the check processing system 122.

At a high level, the middle tier A 112a comprises an electronic computing device operable to receive, transmit, process, store, or manage data and information associated with the environment 100. The middle tier A 112a illustrated in FIG. 1 can be responsible for receiving application requests from one or more client applications (e.g., the consumer capture application 104a, the merchant client capture application 104b, or the teller capture application 104c) or business applications associated with one or more other middle tier systems (112b-c) within environment 100, and responding to the received requests by processing said requests in the associated check processing system 122, and sending the appropriate response from the check processing system 122 back to the requesting application. Alternatively, the check processing system 122 at the middle tier A 112a can be capable of processing and responding to local requests from a user accessing the middle tier A 112a locally. For example, one or more quality assurance professionals may have local access to the middle tier A 112a to perform any necessary quality checks and/or manual keying and corrections required after initial processing and validation from the check processing system 122. Accordingly, in addition to requests from the external systems and applications illustrated in FIG. 1, requests associated with the check processing system 122 may also be sent from internal users, external or third-party customers, other automated applications, as well as any other appropriate entities, individuals, systems, or computers. Further, the terms “client application” and “business application” may be used interchangeably as appropriate without departing from the scope of this disclosure.

As used in the present disclosure, the term “computer” is intended to encompass any suitable processing device. For example, although FIG. 1 illustrates middle tier A 112a as a single server, middle tier A 112a can be implemented using two or more servers, as well as computers other than servers, including a server pool. Indeed, middle tier A 112a may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated middle tier A 112a may be adapted to execute any operating system, including Linux, UNIX, Windows, Mac OS, or any other suitable operating system.

In the present implementation of FIG. 1, middle tier A 112a includes a processor 116, an interface 114, a memory 118, and the check processing system 122. The interface 114 is used by the middle tier A 112a for communicating with other systems in a client-server or other distributed environment (including within environment 100) connected to network 110 (or one or more subsets thereof, such as networks 110a-c), including one or more other middle tiers associated with other financial institutions (e.g., middle tier B 112b and middle tier C 112c), as well as host A 130a associated with middle tier A 112a. Generally, the interface 114 comprises logic encoded in software and/or hardware in a suitable combination and operable to communicate with the network 110. More specifically, the interface 114 may comprise software supporting one or more communication protocols such that the network 110 or interface's hardware is operable to communicate physical signals within and outside of the illustrated environment 100.

As illustrated in FIG. 1, middle tier A 112a includes a memory 118 for storing data and program instructions, the memory 118 including a set of business rules 120 associated with middle tier A 112a and its associated check and payment item processing operations, including financial institution-specific parameters and rules that may differ from other financial institutions, as well as parameters and rules shared among a plurality of related financial institutions. Memory 118 may include any memory or database module and may take the form of volatile or non-volatile memory including, without limitation, non-transitory magnetic media, optical media, random access memory (RAM), read-only memory (ROM), removable media, or any other suitable local or remote memory component. Memory 118 may store various objects or data, including classes, frameworks, applications, backup data, business objects, jobs, web pages, web page templates, database tables, repositories storing business and/or dynamic information, business rules, and any other appropriate information including any parameters, variables, algorithms, instructions, rules, constraints, or references thereto associated with the purposes of the middle tier 112a and its check processing system 122.

As noted, memory 118 is illustrated as storing a set of business rules 120 that can determine specific parameters and rules associated with middle tier A 112a and its check processing system 122. For example, the business rules 120 may determine or specify the appropriate data formats to be used for various files associated with and used by the middle tier A 112a, as well as information on what data formats should be used in association with operations with one or more other financial institutions (or portions thereof, such as a second financial institution's middle tier B 112b). As described, some or all of the business rules 120 may be specific to a particular middle tier or financial institution, while some may also be similar or identical among a plurality of financial institutions and middle tiers. In some instances, the business rules 120 may determine financial institution-specific operations and procedures for handling and processing various items, including fraud-based operations and responses. In some instances the business rules 120 may be a static set of rules or parameters, while in others, they may be able to be modified by an administrator or other user.

As illustrated in FIG. 1, middle tier A 112a includes a processor 116. Although illustrated as a single processor 116 in FIG. 1, two or more processors may be used according to particular needs, desires, or particular embodiments of environment 100. Each processor 116 may be a central processing unit (CPU), a blade, an application specific integrated circuit (ASIC), a field-programmable gate array (FPGA), or another suitable component. Generally, the processor 116 executes instructions and manipulates data to perform the operations of middle tier A 112a and, specifically, the check processing system 122. Specifically, the middle tier A's processor 116 executes the functionality required to receive and respond to requests from various components and their respective applications, as illustrated in FIG. 1, as well as the functionality required to perform the other operations of the check processing system 122.

Regardless of the particular implementation, “software” may include computer-readable instructions, firmware, wired or programmed hardware, or any combination thereof on a tangible, non-transitory, medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate. In the illustrated environment 100, processor 116 executes the check processing system 122 on the middle tier A 112a.

Some general operations of the check processing system 122 are described above. In addition, the check processing system 122 may also include a forwarding system (or application) 124 that determines the destination (i.e., a receiving bank/payor/endpoint) of a particular check or payment item. In the present example, the forwarding system 124 may receive the image file associated with a received check and use that image file, along with any information received or derived at the initial deposit point (102a-c), to determine an expected destination (endpoint), of the received check. In doing so, the forwarding system may identify a particular bank or other financial institution to which the received check is associated. For example, information derived from the MICR line (e.g., through optical character recognition (OCR), an initial scan of the MICR line, or information manually keyed) may be used to identify a particular receiving bank on which a check or payment item is drawn. The forwarding system 124 (and in some cases, the check processing system 122) can then determine the corresponding middle tier associated with that particular receiving (payor/endpoint) bank or financial institution. In order to drastically decrease the processing time of the check or payment item, the check processing system 122 may immediately (or shortly after receipt of the image file) transmit the image file to an appropriate corresponding and communicably coupled middle tier via network 110c. In general, the transmission of the image file associated with the received check or payment item is a much more data- and time-intensive process than transmission of data and other information associated with the check or payment item. By sending the image file immediately upon receipt at the middle tier, or close thereto, the processing time required of the check or payment item throughout the entire system (i.e., the initial middle tier and the second middle tier) can be reduced. For instance, once the image file is sent to the second middle tier of a corresponding second financial institution, the second financial institution's middle tier will be ready to process the check or payment item's image file and associated validation and payment data immediately once the BOFD's middle tier (A 112a) completes its validation and processing operations and provides a transit item or additional information associated with the already-sent image file.

After sending the image file of the received check or payment item, the check processing system 122 performs various levels of check or payment item processing and validation in order to complete the analysis and handling of the received item. In some examples, the check processing system 122 can determine what the level of additional processing necessary for a particular received item may be, and route the image file and associated data of that received item to the appropriate next process point within system 100. For example, the check processing system 122 may first send the received check or payment item to an image analysis module to determine whether the quality of the received image file is sufficient for further processing. Additionally, the MICR codeline read and processing during the initial scanning (e.g., at the teller device 102c) may be compared to the MICR codeline information included within the image file to determine if the information is consistent. Additionally, the check processing system 122 can determine if any amounts or other information not received or input at the initial deposit point device is required to complete and/or continue processing. Still further, the check processing system 122 may run the image file and associated information through one or more suitable fraud detection algorithms and/or systems. If any issues are identified during the check processing system's 122 operations, the check processing system 122 can provide the information associated with the check or payment item to a local or remote bank or financial institution representative, employee, or contractor, who can manually perform any additional processing steps required to correct the issues identified during the check processing operations. In most cases, the information received at the initial deposit point devices will be sufficient, and the check processing system 122 may continue its operations.

Once the check or payment item completes its validation and general processing as described above, the check processing system 122 forwards data associated with the received and/or processed check or payment item to a host system A 130a associated with the check processing system's middle tier A 112a. In general, information detailing any credits and/or debits associated with the payment item is sent to the host system A 130a in order to settle the accounts associated with the check or payment item, and update any accounts maintained at the host system A 130a. In parallel with the sending the information to the host system A 130a, the middle tier A 112a (via the check processing system 122) can forward the finalized set of data and information associated with the processed check to the receiving (payor/endpoint) bank determined and confirmed during the check processing system's operations. In some instances, the confirmed receiving bank (payor/endpoint) may differ from the receiving bank (payor/endpoint) to which the image file was initially sent. In those instances, the image file may be resent by the middle tier A 112a, this time to the newly determined and correct receiving (payor/endpoint) bank (or middle tier). Further, the middle tier A 112a can forward the finalized information to host system A 130a (the host system associated with middle tier A 112a) that can perform the actual settlement operations and actions of processing the credits and debits of those accounts maintained or managed by the financial institution or bank associated with middle tier A 112a and host system A 130a.

Once middle tier A 112a finalizes its processing operations, the middle tier A 112a sends the results of the processing to its associated host system A 130a via network 110b and the interfaces (114, 132) of each system. In general, host system A 130a applies the credits and debits associated with the received checks and payment items to one or more accounts of the associated financial institution. For instance, if the check or payment item received at the initial point of deposit represented a check written to a customer of the financial institution, after processing and receiving the corresponding information from middle tier A 112a, the host system A 130a would apply the appropriate credit to the account associated with the customer by updating the customer's account information. Once the credit (or debit in cases) is applied, the host system A 130a can return that information to middle tier A 112a, confirming the application of the credit (or debit) has been performed.

Similar to middle tier A 112a, the host system A 130a may comprise one or more application servers used to maintain and monitor the accounts of customers associated with a financial institution. As illustrated, the host system A 130a includes an interface 132, a processor 134, a settlement system application 136, and memory representing a set of account information 138a associated with the customers of the financial institution. In general, the interface 132 and the processor 134 of the host system A 130a may be similar to the interface 114 and processor 116 described above in relation to middle tier A 112a, although any suitable alternative type of interface and/or processor(s) may be used with the host system A 130a in various embodiments or implementations. In general, the processor 134 executes instructions and manipulates data to perform the operations of host system A 130a and, specifically, the settlement system 136. Specifically, the host system A's processor 134 executes the functionality required to receive and respond to requests from various components and their respective applications as illustrated in FIG. 1, as well as the functionality required to perform the other operations of the settlement system 136.

The settlement system 136 is any software used to receive and interpret information from corresponding middle tier A 112a regarding received transactions resulting in a credit and/or debit to an account maintained by the host system A 130a. As described in the present disclosure, middle tier A 112a performs the processing and validation of received check and payment item transactions prior to forwarding information to host system A 130a. As such, the host system A 130a, and in turn, the settlement system 136, receive a finalized set of credit and debit information from the middle tier A 112a that can be posted as a final post transaction to the corresponding account (or accounts) maintained by the host system A 130a. The settlement system 136 can interact directly with the account information 138a to update (i.e., credit or debit) the appropriate accounts of customers according to the information received from middle tier A 112a. Importantly, the final post of the transaction to a customer's account can be used to complete a transaction, and complete the primary processing performed at the first financial institution (i.e., the bank associated with middle tier A 112a and the host system 130a). Once the final post is performed, the settlement system 136 can return a confirmation to the middle tier A 112a notifying the middle tier that the associated settlement operations at the host system A 130a have been performed. In instances where the middle tier's processing identifies one or more issues with the received check or payment item image file or associated data, the settlement system 136 may be directed to apply a memo (or temporary) post to the associated customer account information 138a. Once the settlement system 136 receives information confirming the middle tier A's 112a completion of processing the corresponding check or payment item, the settlement system 136 can modify the memo post to a completed final post, either confirming the transaction information associated with the memo post or modifying the transaction information to match the information resulting from the middle tier A's 112a processing operations.

The account information 138a stored at the host system A 130a may be stored in memory similar to that described in regard to memory 118, as well as any other suitable memory. Further, the account information 138a may be stored locally on the host system A 130a, as illustrated in FIG. 1, while in alternative instances, all or a portion of the account information 138a may be stored remote from the host system A 130a. The account information 138a itself may be stored as any appropriate type of file, including a relational database, a mainframe database, a text file, a flat file, or any other suitable storage file or mechanism.

In general, host systems 130 and their corresponding middle tiers 112 can communicate using multiple message formats and over multiple communication protocols. Further, communications between host systems and middle tiers may be encrypted using any suitable encryption technique in order to protect the sensitive information transmitted between the systems. In some instances, middle tiers may correspond with host systems using message queuing (MQ), a queue-based communication protocol. System developers can define queues for a targeted communication end point. The two systems communicating with each other through the queue do not have to be active at the same time, which makes MQ suitable for asynchronous communication. In other embodiments, TCP/IP-based communications, hypertext transfer protocol (HTTP) communications, and various legacy communication techniques, may be used to communicate between the systems. The legacy communication techniques may include an SNA data service that supports LU2 and LU6.2 communication. In practice, any suitable method of communication may be used to communicate information between the host systems 130 and their respective middle tiers 112.

Once the host system 130a completes its update of the account information, the host system 130a may send a confirmation of completed transaction to the middle tier A 112a. The confirmation may be received by middle tier A 112a while the customer continues interactions with the teller (or other initial deposit points). In those instances, the operations of the present disclosure can allow issuance of a transaction receipt confirming a completed account transaction reflecting the final posting of the transaction to the customer's account at the corresponding financial institution.

Additionally, after processing is completed, the generated and processed image file may be stored in an image repository and/or image archive 140a, either by the middle tier A 112a or by the host system A 130a. The image repository and/or image archive 140a may be used to store image files for backup purposes, as well as to satisfy regulatory and legal obligations associated with the management of financial transaction information. The image repository and/or image archive 140a may be local or remote to the corresponding financial institution, and information may be sent via a portion of the network 110 (here, network 110b) through the interface 114 of the middle tier A 112a (and/or the interface 132 of the host system A 130a) to the location at which the image repository and/or archive 140a is located. In some instances, the image repository and/or image archive 140a may be dedicated to a single financial institution, middle tier, and/or host system, while in other instances, the image repository and/or image archive 140a may be used by a plurality of financial institutions to store the required image files (and associated data). In some instances, financial institutions may use a separate image repository and an image archive for different purposes. For instance, the image repository may be used for short-term storage, while the image archive may be used for long-term storage (either according to business rules defined for a particular financial institution, or by regulatory or legal requirements defined by an outside agency or industry group). As illustrated, each financial institution (i.e., middle tier and host system) may be associated with an image repository and/or archive (140b, c).

Once the transaction is finalized, and the middle tier A 112a receives confirmation from the corresponding host system A 130a, one or more transit items associated with the transaction are generated by middle tier A 112a comprising the set of transaction information and data associated with the received (and now processed) check or payment item. The transit items are generated and sent to be associated with the image files previously sent to the destination middle tier associated with the receiving financial institution (payor/endpoint), and which are to be provided to the receiving financial institution for presentment via the corresponding middle tier. Each check or payment item may be associated with its own transit item, allowing processed check or payment items to be sent to the receiving financial institution as soon as the middle tier and host system processing is complete. In general, both the transit item and the previously-sent image file may be associated with a common identifier, allowing the middle tier of the receiving financial institution (payor/endpoint) to immediately associate the newly received transit item data with the stored image file and begin processing the corresponding item through its middle tier and host. In some instances, the transit items generated by middle tiers may be generated in a common format unique to and/or consistent with the transactions performed between the various middle tiers illustrated in FIG. 1. In some instances, the transit items may be sent using an industry standard format, such as X9.37 files, to transmit the appropriate data between middle tier systems. In other instances, the transit items generated by the middle tier may only include information regarding debits to be covered by the corresponding financial institution. Upon presentment of the transit item (and corresponding image file), the receiving financial institution (or payor bank/endpoint) can process the transit item/image file combination according to the middle tier settings and business rules of the receiving financial institution. As illustrated in FIG. 1, transit items can be sent from middle tier A 112a to the other middle tiers (middle tier B 112b and middle tier C 112c) via network 110c, which may be a dedicated communications channel, a VPN between financial institutions, or any other network, including those described above.

FIG. 1 illustrates two additional sets of middle tiers and host systems, including middle tier B 112b and host system B 130b, and middle tier C 112c and host system C 130c. In general, a second financial institution (Bank B) may be associated with middle tier B 112b and host system B 130b, and a third financial institution (Bank C) may be associated with middle tier C 112c and host system C 130c. Further, the other middle tiers (B 112b and C 112c) may be composed of similar systems and components as that of middle tier A 112a (such as including similar processors, check processing systems, memory, and interfaces), while in other instances, one or both of the other middle tiers B 112b and C 112c may be composed of different and/or analogous components (such as including different types of processors, different check processing systems, etc.). In any event, both middle tier B 112b and C 112c are capable of receiving image files from middle tier A 112a when those files are initially sent. Those image files may be stored in the corresponding local memories of those middle tiers (not illustrated in FIG. 1), and kept until the additional information and data, including the transit items associated with those image files, are received from middle tier A 112a. Once the image file and related data corresponding to a particular check or payment item is received at middle tier B 112b or C 112c, those received files are associated together based on their corresponding unique identifiers (or another relationship identifying the relationship between the image file and/or the transit item or associated data).

Once the image file and transit item are associated at the receiving (payor/endpoint) bank, the middle tier at that financial institution performs its normal validation and processing operations. The validation and processing operations of middle tier B 112b and/or middle tier C 112c may be identical or similar to those of middle tier A 112a, or alternatively, may include additional or fewer validation and processing steps as is required by the associated financial institution. In some cases, the data received at the receiving middle tier may include information on the validation and processing steps performed by the originating (or sending) middle tier (middle tier A 112a, in this instance). In some scenarios, the validation and processing steps of the originating middle tier (middle tier A 112a, for example) may be sufficient or acceptable for validation purposes of the receiving middle tier (middle tier B 112b, for example) such that no additional validations, or only a subset of the typical validations performed by middle tier B 112b, may need to be performed. The determination of what validations are acceptable or that may cause a modification to the respective validations and processing steps at the receiving middle tier can be defined in the corresponding business rules associated with each respective middle tier system. For instance, while middle tier B 112b may accept the validations of middle tier A 112a and perform fewer validations than normal based on the operations performed at middle tier A 112a, middle tier C 112c may perform the entire set of validations and/or operations regardless of the validations performed at middle tier A 112a.

If the receiving middle tier (B 112b or C 112c) performs its normal operations, the image file and transit item may be processed similar to the initial processing performed at middle tier A 112a, including codeline verification of the scanned MICR line from the image file, an image quality analysis, an amount keying (if necessary), and fraud-related detection and suspect review. The receiving middle tiers may perform similar operations as middle tier A 112a to process the image file and transit item, or may perform alternative, additional, or different operations to perform the same. In any event, once the validation and processing of the received image file and associated data is complete, the receiving middle tier (B 112b or C 112c) sends the finalized information to the corresponding host system 130 (host system B 130b and host system C 130c). The corresponding host system 130 (host system B 130b and host system C 130c), which may include components similar to those of host system A 130a, then updates the corresponding set of account information 138b or 138c with the transaction information received from the originating financial institution. As illustrated, communications between the additional middle tiers and host systems are performed through networks 110d and 110e, which may be dedicated communication channels between the respective components or any other suitable means of communication. Once the records are updated in the corresponding sets of account information (138b or 138c), a confirmation can be sent from the host system B or C (130b or 130c) to the corresponding middle tier B or C (B 112b or C 112c), which may be forwarded back to the originating middle tier to notify of the completion of the transaction (e.g., middle tier A 112a). Additionally, each financial institution (and thus, middle tier and host system) may be associated with an image repository and/or archive 140b and 140c, respectively, to store the image files and associated data according to financial institution-specific requirements, as well as based on industry standards and regulatory requirements.

In FIG. 1, middle tier C 112c is illustrated as including an information adapter 142. The information adapter 142 can be used to translate information received from other middle tiers into a format or information set compatible with the format used in middle tier C 112c. Additionally, any information sent from middle tier C 112c may be modified by the information adapter 142 to place that information or associated data into a format compatible with one or more associated middle tiers. In some instances, the information adapter 142 may allow legacy middle tier applications to communicate and coordinate with newly-added, updated, or other non-legacy middle tiers without losing the ability to scale the system of the present disclosure.

While FIG. 1 is described as containing or being associated with a plurality of elements, not all elements illustrated within environment 100 of FIG. 1 may be utilized in each alternative implementation of the present disclosure. For example, although FIG. 1 depicts a consumer capture device 102a, a merchant capture device 102b, and a teller capture device 102c, any combination or configuration of devices may be used to receive and scan checks and payment items into the system (for example, ATMs). Further, although FIG. 1 depicts each middle tier 112 as a single application server, any or all of the middle tier architectures may include two or more servers. In some instances, one or more system administrators may be local or external to the illustrated system, and may have access to the business rules 120 of a particular middle tier in order to change local settings associated therewith. Additionally, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes, in addition to those purposes described herein.

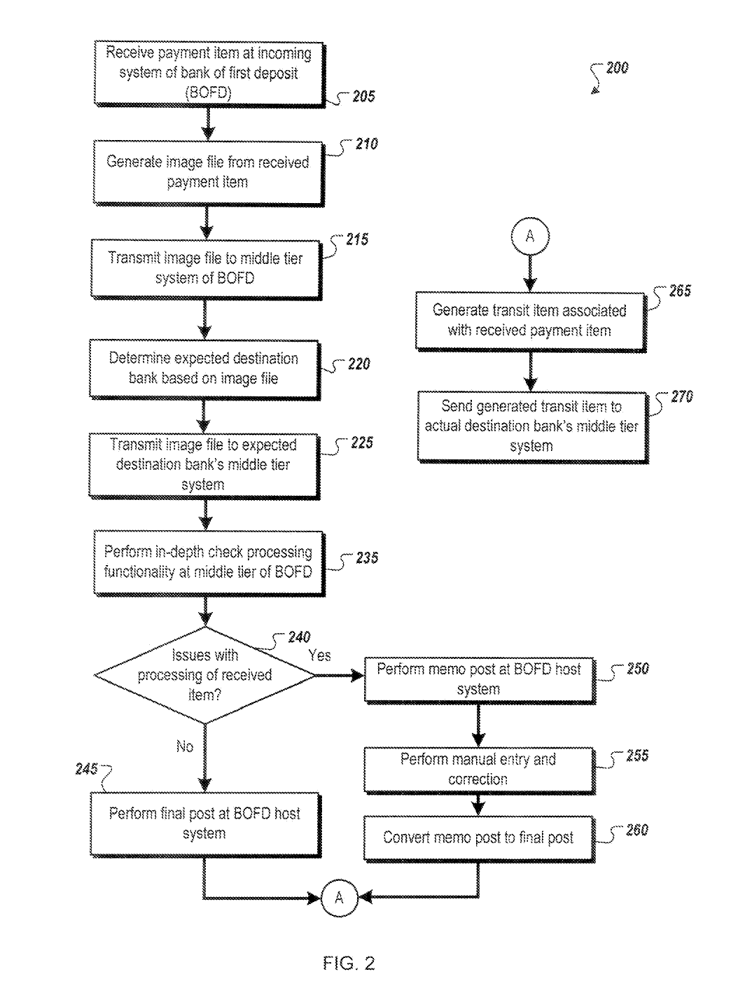

FIG. 2 is a flowchart illustrating an example method 200 for performing real-time, straight-through processing and real-time presentment of a check or payment item from the perspective of the BOFD. For clarity of presentation, the description of method 200 that follows references environment 100 illustrated in FIG. 1 for example elements that may perform one or more of the described operations. However, it will be understood that method 200 may be performed, for example, by any other suitable system, environment, or combination of systems and environments, as appropriate.

At 205, a check or payment item is received at a receiving, or incoming, system of the bank of first deposit (BOFD). The incoming system of the BOFD may include, among others, a teller workstation in a BOFD branch location, a merchant-based capture system used to capture and deposit check and payment items remotely at a merchant or retailer, or a consumer-based application where checks and other payment items can be deposited online through a web-based portal or application. Upon receiving the check or payment item, an image file containing scanned images or snapshots of the received check or payment item is generated at 210. In some instances, the image file may be generated using a traditional flatbed scanner, a digital camera (including cameras included on smartphones and other devices), or through other suitable means. In many instances, the image file may include an image of the front and back of the check or payment item, as well as a capture of the MICR line data.

At 215, the image file is transmitted from the incoming system of the middle tier system of the BOFD. The length and type of transmission at 215 depends on the incoming system at which the check or payment item was received, as well as the location of the BOFD's middle tier system. In the scenario where the payment item is received at a teller location, the transmission of the image file to the BOFD may be a submission of the image file to a back-end system located at the BOFD, or to a system connected to the middle tier system by a VPN or internal network within the BOFD's information technology systems. If, alternatively, the incoming system where the check or payment item was received is remote from the BOFD (i.e., at a merchant capture device or a consumer capture device), then the image file may be packaged and sent via the Internet, a private connection, or other suitable type of network to the BOFD's middle tier system. In general, communications of the image file may be encrypted to maintain security of the check or payment item information during transmission.

At 220, the middle tier system (or alternatively, a component thereof, an external component, or an application associated with the generation of the image file) determines an expected receiving (payor/endpoint) bank based on the image file. Additionally, information received or entered at the incoming system of the BOFD may also be used to determine the expected receiving bank (payor/endpoint) of the image file (and therefore, the check or payment item itself). In one example, the image file may be processed using optical character recognition (OCR) and the initial scan of the MICR line may be decoded to determine the likely or expected receiving (payor/endpoint) bank of the image file and associated payment item. In other instances explicit information captured at the incoming system, such as manually keyed entries, may be used to determine the expected receiving (payor/endpoint) bank of the image file and the payment item. At 225, the image file is transmitted to the receiving (payor/endpoint) bank's (or financial institution's) middle tier system. As illustrated in FIG. 1, any number of middle tier systems may be connected to each other through a suitable, and in some cases, secured and/or encrypted, network connection or connections. Using these connections, the middle tier of the BOFD can direct an electronic transmission of the generated image file to the expected receiving (payor/endpoint) bank's middle tier. As illustrated, the generated image file is sent prior to any additional processing and validation of the image file (other than determining the expected receiving (payor/endpoint) bank). In sending the generated image file at this time, the usual time delay associated with sending image files to the receiving (payor/endpoint) bank is generally avoided, as the image files can be effectively streamed to their expected receiving (payor/endpoint) banks while the local BOFD processing and validation processes are performed. Once those validation and processing steps are completed, the data associated with those steps is sent to the receiving (payor/endpoint) bank, where the information and image file are associated and combined, and additional processing at the receiving (payor/endpoint) bank is performed.

Returning to FIG. 2, at 235 the middle tier system at the BOFD performs the in-depth processing operations associated with check processing and validation. These operations include any number of steps and validations, including, for example, MICR codeline verification, image quality analysis, amount keying, fraud detection, and suspect review, among others. Generally, the middle tier analysis confirms the information received at the teller (or incoming system), as well as the image file quality, and uses that information to finalize a transaction associated with the received payment item. In most instances, the middle tier operations require little to no human interaction to perform the required processes and create the associated transactions. In some cases, however, issues may arise that require manual intervention to complete the process. At 240, the system performing method 200 determines whether any issues arise with regard to the processing or validation of the received payment item. If no issues arise, method 200 continues at 245, where the system performs a final post of the transaction at the BOFD's host system. The final post includes modifications to any associated customer accounts, including crediting or debiting customer accounts as necessary. Because most transactions do not require manual intervention due to processing and validation issues, many transaction can be completed in real-time (or near real-time) as a customer interacts with the incoming system or teller. In those instances, the customer may receive, at the end of the interactions, a receipt indicating the completion of the transaction and account information accurately reflecting the current status of the customer's account.

If, however, issues arise during the validation and processing operations, method 200 continues at 250, where the middle tier system of the BOFD performs a memo post at the BOFD's host system. The memo post reflects a temporary entry in the customer's account that may be changed or updated prior to completion, or the final post. In prior systems, the memo post was generally used prior to the completion of a batch process finalizing a set of financial transactions. In the currently described system, the memo post may be limited to uses when the in-line processing of a transaction is delayed, realizing a much higher percentage of final posts than memo posts when the system is practiced. At 255, manual entries, corrections, and reviews of the transaction, image file, and associated data are performed. These manual steps may be performed by individuals or representatives local to the middle tier system in some instance, or by remotely located employees or contractors in other instances. Once the manual processes are completed, at 260 the information is submitted to the middle tier, confirmed, and the memo post in the customer's account is converted to a final post. The transaction is then finalized at the BOFD, and method 200 continues at 265.

At 265, a transit item associated with the received check or payment item is generated. Generally, transit items may be used to send transaction information to the receiving financial institution associated with the received check or payment item. Each check or payment item may have its own transit item generated, the transit item including information describing credits or debits to be applied to the receiving financial institution's customer or internal accounts. In some instances, these transit items may be called “on others items,” indicating that the check or payment item is drawn on another financial institution. In some instances, the check or payment item received at 205 may be provided by the BOFD's customer, as well as drawn on the BOFD itself (an “on us item”). In these instances, all processing may be performed in-house at the BOFD, with the BOFD's host system performing the necessary transactions to accurately reflect the account changes related to the transaction. As illustrated in FIG. 2, however, the received check or payment item is not drawn on the BOFD, and therefore is sent as a transit item to the receiving (payor/endpoint) bank. During the in-depth processing steps of 235, the middle tier of the BOFD determines the actual receiving (payor/endpoint) bank of the check or payment item, including a comparison as to whether the expected receiving bank (payor/endpoint) determined at 220 is the same as the actual receiving (payor/endpoint) bank. In most cases, the two will match, and the previously-transmitted image file will already have arrived at the actual receiving (payor/endpoint) bank. In those cases, the transit item may not include the image file, and may instead include a unique identifier that can be used by the actual receiving (payor/endpoint) bank to match the previously-received image file with the transit item (sent at 270). If, however, the actual receiving (payor/endpoint) bank and the expected receiving (payor/endpoint) bank do not match, the corresponding image file is resent to the actual receiving (payor/endpoint) bank with, or included in, the transit item.

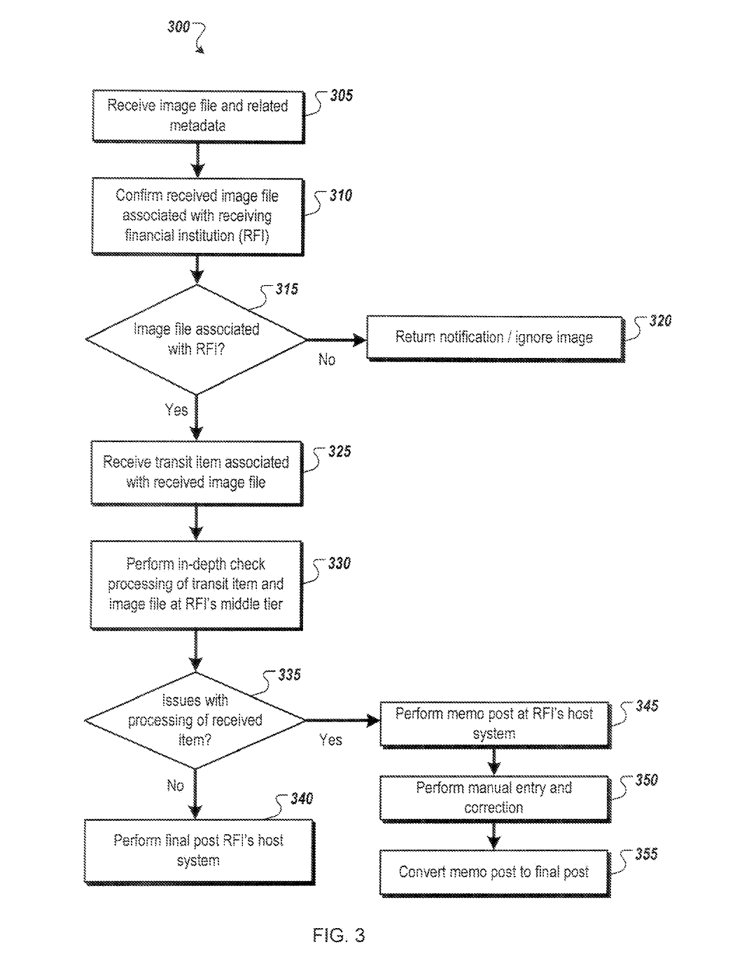

FIG. 3 is a flowchart illustrating an example method 300 for performing real-time, straight-through processing and real-time presentment of a check or other payment item from the perspective of a receiving (payor/endpoint) bank or financial institution (RFI) associated with a check or payment item received at a BOFD. Method 300 may be performed by any suitable system, but for clarity of presentation, the description that follows uses system 100 of FIG. 1 as a particular example for describing the method steps. However, another suitable system or combination of systems may be used to perform method 300 in alternative implementations.

At 305, the RFI receives an image file (and, in some cases, metadata or other information associated with the image file). Generally, the RFI receives the image file from an associated middle tier system associated with a BOFD (or another financial institution from which payment items can be received for processing). The image file is generally received at the RFI's corresponding middle tier system via a network or other communication means over which information is shared or exchanged between the financial institutions. The image file will generally include a unique identifier that can be used to later connect or associate additional information and transaction data with the received image file. In general, the image file may include an image of the front and/or back of a check or other payment item, as well as an image or other information associated with the MICR line of the payment item. In some instances, the received image file can be stored in a local image repository until additional information is received from the BOFD. At 310, the RFI's middle tier can review the image file and any associated metadata received with the image file to confirm that the image file is associated with and meant for the RFI. At 315, the middle tier determines whether the image file is associated with the RFI. If the image file has incorrectly been sent to the RFI, method 300 continues at 320, where the RFI can return a notification to the originating financial institution (here, the BOFD) to notify that institution of the error. Alternatively, the RFI can ignore and disregard the image file. In most cases, incorrect image files will not receive additional data, as the in-depth processing at the originating financial institution will generally identify the error before additional information is transmitted to the RFI. If additional information is received for an image file that is not associated with the RFI, the RFI may then provide an error or other notification to the originating financial institution.

If, however, the image file is associated with the RFI, method 300 continues at 325, where a transit item associated with the received image file is received. The time between receiving the image file and receiving the transit item may vary in different situations (e.g., when additional processing and validation is required at the BOFD). In many instances, the transit item is received at the RFI only after the BOFD completes and finalizes its processing, validation, and posting of the corresponding transaction. In any event, the transit item is received at 325. The association of the transit item with the received image file may be performed based on identical, matching, or related unique identifiers associated with both the received image file and the received transit item. For example, the RFI's middle tier may perform comparisons of the received transit item's identifier with those of a plurality of stored image files prior to properly associate the two files.

Once the received transit item is associated with the correct image file, the RFI's middle tier performs an in-depth processing of the transit item and image file at 330. As with the BOFD in method 200, the in-depth processing operations of 330 may include processing and validation operations including, for example, MICR codeline verification, image quality analysis, amount keying, fraud detection, and suspect review, among others. In some instances, the processing and validation operations may be identical for both the BOFD's middle tier and the RFI's middle tier. In other instances, the validation and processing operations of the RFI may include additional or fewer operations than the similar process at the BOFD, as well as performing the various operations in a different order than the BOFD. In some instances, the BOFD's middle tier may supply the RFI's middle tier with information regarding the validation and processing operations and results performed at the BOFD. In some instances, and based on the received information on the BOFD middle tier's analysis, the RFI may accept certain validation or processing operations as completed or unnecessary at the RFI's middle tier (e.g., the image quality analysis operations). In other instances, the RFI's middle tier may perform the standard validation and processing operations regardless of the results returned at the BOFD.

At 335, the RFI's middle tier system determines whether any issues arise during the processing of the received transit item and image file. If no issues arise, method 300 continues at 340, where the RFI middle tier submits the transaction information to the RFI's host system, where the associated customer account information is updated using a final post. Alternatively, if issues arise during processing and validation, method 300 continues at 345, where the RFI's middle tier system requests the RFI's host system to perform a memo post. At 350, any manual review, corrections, and/or entries may be performed by users associated with the RFI's middle tier. Upon completion of the additional manual processing, the RFI's middle tier requests and/or causes the RFI host system to convert the memo post into a final post at 355.

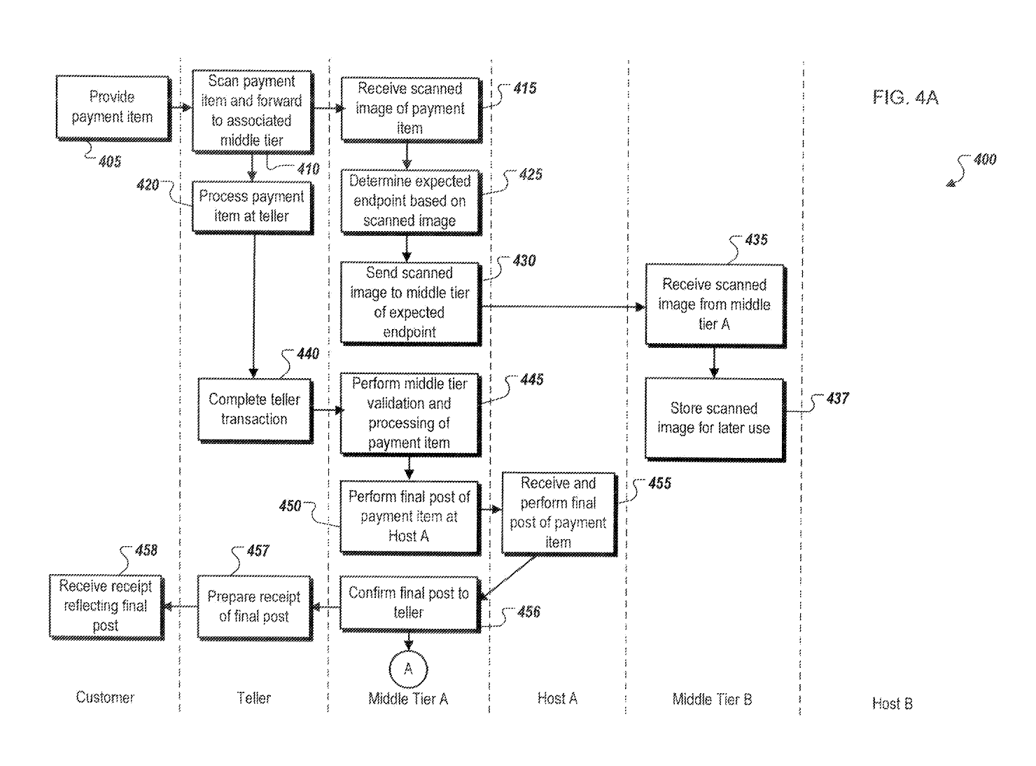

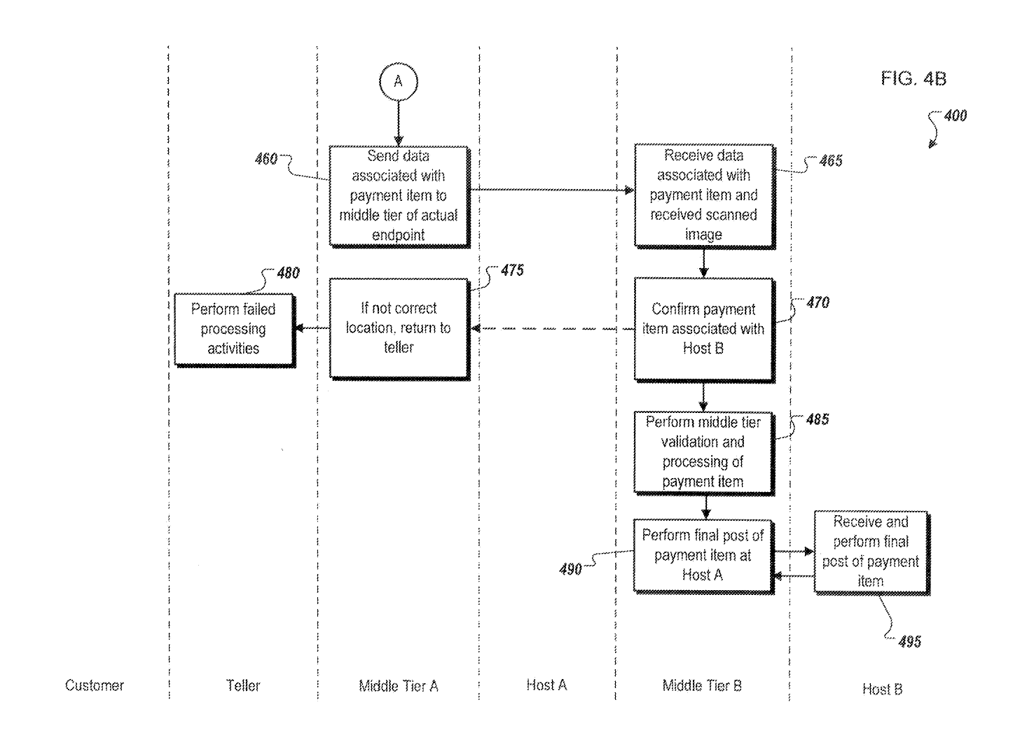

FIG. 4 is an example signaling and flow diagram illustrating operations associated with performing real-time, straight-through processing and real-time presentment of a check or other payment item. Specifically, the system of FIG. 4 illustrates operations across a customer, a teller (or teller-equivalent), a middle tier system and a host system associated with a BOFD (middle tier A and host system A), and a middle tier system and a host system associated with an RFI (middle tier B and host system B). Although certain operations are illustrated as associated with or performed by a particular element, any suitable combination of illustrated or non-illustrated elements and operations or processes may be used to perform the steps and operations described.

At box 405, a customer provides a check or payment item to a bank of first deposit (BOFD). As illustrated in the example of FIG. 4, the provision of the check or payment item is provided to a teller At box 410, the payment item is scanned (or otherwise captured so that an image file of the payment item is generated), with the scanned image file being sent to the middle tier A associated with the teller. Simultaneously with the image file being sent to the middle tier A, the teller performs a set of initial processing of the check or payment item at the teller in box 420. In some instances this may include the teller adding customer-specific information along with the payment item, such as a customer account number, a driver's license number, and other related operations.

Returning to box 415, middle tier A receives the scanned image file associated with the payment item. At box 425, middle tier A determines an expected receiving (payor/endpoint) bank for the check or payment item based on the scanned image file (or alternatively, any information included or transmitted with the image file, including data entered by the teller). Once the expected receiving (payor/endpoint) bank is determined, at box 430 middle tier A forwards the image file (containing at least the image file and a unique identifier for associating additional, related information) to middle tier B of the second system, where at box 435 middle tier B receives the image file from middle tier A. Middle tier B stores the scanned image file and associated unique identifier in local (or remote) storage for later use and association with finalized transit items at box 437. By sending the image file prior to the processing steps at the middle tier A, the present system allows for immediate presentment at middle tier B once the transit item is received. Additionally, the transmission of the image file from one middle tier to another generally constitutes a majority of the data exchanged between financial institutions. By performing this time- and data-intensive task early in the operations, and specifically while various other operations are being performed at the BOFD's middle tier A, the time required to clear and finalize transactions throughout the system is greatly reduced. The transmission of image files and other data between the respective middle tiers may be performed over any appropriate communication protocols and/or channels, including a VPN between the systems, a dedicated network connection, or encrypted communication over the Internet, among others.

At box 440, the teller transaction (or teller-equivalent transaction, such as a merchant capture transaction or consumer device-based transaction) is completed, or at least the initial teller processing of the check or payment item is completed. The scanned image file and the results of the teller processing are provided to middle tier A of the BOFD, where at box 445 the middle tier performs the various middle tier validations and processing operations on the payment item and image file, including an image quality analysis, a MICR codeline confirmation, and other related processes. Once the middle tier processing and validation of the payment item is complete, the middle tier A requests a final post of the payment item transaction information at host system A at box 450. At box 455, the host system A receives the final post request, and assuming all criteria are met, performs the final post of the payment item transaction to the related customer accounts.

Once the final post of the transaction is completed at box 455, the host system A can provide the middle tier A with a confirmation that the transaction has posted. Although not shown in FIG. 4, once the final post occurs, the teller can provide the customer with a receipt reflecting the final post of the transaction and confirming the completion of payment item processing. In previous systems, this was unavailable, as the check processing and validation steps were performed outside of the middle tier and in a separate and distinct process, usually taking at least until the end of the current business day to complete. Additionally, once the final post of the payment is completed by the host system A, a notification of that final post is returned to middle tier A. At box 456, the middle tier A confirms the final post of the transaction with the teller and/or the teller-equivalent. At 457, the teller (or teller-equivalent) prepares a receipt for the customer reflecting the status of the final post of the transaction in financial institution A's system, and at 458 the customer receives the prepared receipt reflecting the final post.

At box 460, middle tier A sends data associated with the finalized transaction of the payment item (at the BOFD) to the middle tier of the actual receiving (payor/endpoint) financial institution. As described in FIGS. 2 and 3, the actual receiving (payor/endpoint) bank will generally be the same as the expected receiving (payor/endpoint) bank, but the actual receiving (payor/endpoint) bank is the confirmed receiving (payor/endpoint) bank based on the processing performed at the middle tier A. Further, the data associated with the final transaction and posting of the payment item may be included in a newly-generated transit item, including the information relevant to the posted transaction, including any debits or credits due from or to the RFI associated with middle tier B and host system B. At box 465, middle tier B receives the transit file or other data associated with the payment item and the previously received image file, and further, may associate the transit file (or other data) with the scanned image file stored by the middle tier at box 437. Once associated, middle tier B can confirm whether the payment item associated with both the received transit item and image file are associated with an account or accounts managed or stored by host system B at box 470. If middle tier B determines that the payment item was erroneously received, a notification may be returned to middle tier A, and middle tier A may handle any internal corrections at box 475, such as by providing the erroneous information to a teller for manual correction at box 480.

If, however, the image file and the transit item are associated with information located at host system B, then at box 485, middle tier B can perform the associated processing and validation of the transit item and image file. Once the processing and validation operations are complete, middle tier B can request that a final post of transaction data associated with the received transit data and image file be performed at the host system B (as illustrated in box 490). That request is sent to host system B, and at box 495, the host system B performs the final post of the transaction associated with the image file and transit item corresponding to the payment item provided by the customer at box 405.

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously and/or in different orders than as shown. Moreover, environment 100 may use processes with additional steps, fewer steps, and/or different steps, so long as the methods remain appropriate.

A number of embodiments of the present disclosure have been described. Nevertheless, it will be understood that various modifications may be made without departing from the spirit and scope of the present disclosure. For example, the processes described herein may also be applicable to any electronic payment in which real-time and straight-through processing is accomplished via online communication between the respective middle-tiers of the BOFD and the receiving financial institution. Accordingly, other embodiments are within the scope of the following claims.

What is claimed is:

1. A method comprising:
receiving a payment item for processing at a first financial institution;
generating an image file associated with the received payment item;
transmitting the generated image file to a second financial institution associated with the payment item upon generation of the image file;
processing the received payment item and generated image file for posting a transaction to a customer account at the first financial institution; and
after completing processing of the received payment item and generated image file:
generating a transit item associated with the processed payment item; and
transmitting the generated transit item to the second financial institution for association with the transmitted image file.

2. The method of claim 1, wherein the payment item comprises a check.

3. The method of claim 1, wherein the payment item is received via an incoming system associated with the first financial institution.

4. The method of claim 3, wherein the incoming system associated with the first financial institution comprises a teller capture device, a merchant capture device, an automated teller machine (ATM), or a consumer capture device.

5. The method of claim 1, wherein generating the image file associated with the received payment item includes capturing digital images of one or more of the following: a front of the payment item, a back of the payment item, and a Magnetic Ink Character Recognition (MICR) line from the payment item.

6. The method of claim 1, wherein processing the received payment item and generated image file for posting to the customer account at the first financial institution includes performing one or more of the following: MICR codeline verification, image quality analysis, manual amount keying, fraud detection, and suspect review.

7. The method of claim 1, wherein the image file is associated with a first unique identifier, and the transit item is associated with a second unique identifier, the method further comprising:
associating the first unique identifier of the image file with the second unique identifier of the transit item at the second financial institution; and
processing the associated image file and transit item for posting to the customer account at the second financial institution.

8. The method of claim 1, wherein receiving the payment item and generating the image file are performed at an incoming system of the first financial institution, and wherein processing the received payment item and generated image file for posting the transaction to the customer account at the first financial institution is performed at a middle tier system of the first financial institution, the method further comprising:
posting the transaction to the customer account stored in a host system of the first financial institution.

9. The method of claim 8, wherein posting the transaction to the customer account at the first financial institution includes:
sending transaction information derived during the processing of the received payment item and the generated image file to the host system of the first financial institution from the middle tier system of the first financial institution.

10. The method of claim 8, wherein generating the image file associated with the received payment item includes transmitting the generated image file from the incoming system of the first financial institution to the middle tier system of the first financial institution;
wherein generating a transit item associated with the processed payment item is performed by the middle tier system of the first financial institution; and
further wherein transmitting the generated transit item to the second financial institution for association with the transmitted image file includes transmitting the generated transit item from the middle tier system of the first financial institution to the middle tier system of the second financial institution.

11. The method of claim 1, wherein transmitting the generated image file to the second financial institution associated with the payment item upon generation of the image file includes determining the second financial institution to which the image file is to be sent based on information derived from the generated image file.

12. The method of claim 11, wherein processing the received payment item and generated image file includes confirming the determination of the second financial institution to which the image file is to be sent.

13. A computer storage medium encoded with a computer program, the program comprising instructions that when executed by data processing apparatus cause the data processing apparatus to perform operations comprising:
generating an image file associated with a payment item received at a first financial institution;
transmitting the generated image file to a second financial institution associated with the payment item upon generation of the image file;
processing the received payment item and generated image file for posting a transaction to a customer account at the first financial institution; and
after completing processing of the received payment item and generated image file:
generating a transit item associated with the processed payment item; and
transmitting the generated transit item to the second financial institution for association with the transmitted image file.

14. The medium of claim 13, wherein the payment item comprises a check.

15. The medium of claim 13, wherein the payment item is received via an incoming system associated with the first financial institution.

16. The medium of claim 13, wherein generating an image file associated with the received payment item includes capturing digital images of one or more of the following: a front of the payment item, a back of the payment item, and a Magnetic Ink Character Recognition (MICR) line from the payment item.

17. The medium of claim 13, wherein processing the received payment item and the generated image file for posting to the customer account at the first financial institution includes performing one or more of the following: MICR codeline verification, image quality analysis, manual amount keying, fraud detection, and suspect review.

18. The medium of claim 13, wherein the image file is associated with a first unique identifier, and the transit item is associated with a second unique identifier, the first unique identifier and the second unique identifier representing a related pair of identifiers to allow for association of the image file and the transit item at the second financial institution.

19. The method of claim 18, wherein the first unique identifier and the second unique identifier are identical.

20. A system comprising:
an incoming system associated with a first financial institution adapted to:
receive a payment item for processing;
generate an image file associated with the received payment item; and
transmit the generated image file to at least one middle tier server associated with the first financial institution;
one or more middle tier servers in a middle tier system associated with the first financial institution adapted to:
identify a second financial institution associated with the received payment item;
transmit the generated image file to the second financial institution;
process the received payment item and generated image file in preparation for posting a first transaction associated with the received payment item to a first customer account at the first financial institution; and
after completing processing of the received payment item and generated image file:
generate a transit item associated with the processed payment item; and
transmit the generated transit item to the second financial institution for association with the transmitted image file; and
one or more middle tier servers in a middle tier system associated with the second financial institution adapted to:
initially receive the transmitted image file from the middle tier system of the first financial institution;
store the received image file in an image file repository storing a plurality of received image files;
receive the transmitted transit item from the middle tier system of the first financial institution; and
associate the received transit item with the corresponding image file from the image file repository; and
process the associated transit item and image file in preparation for posting a second transaction associated with the associated transit item to a second customer account at the second financial institution.

21. The system of claim 20, wherein the incoming system associated with the first financial institution includes a teller at a local branch of the first financial institution.

22. The system of claim 20, wherein the middle tier system of the first financial institution is adapted to communicate, via a network, with the middle tier system of the second financial institution.

23. The system of claim 20, wherein the one or more middle tier servers in the middle tier system associated with the first financial institution are further adapted to transmit the generated image file to the second financial institution prior to processing the received payment item and generated image file in preparation for posting a transaction associated with the received payment item to the customer account at the first financial institution.
